(19) United States
(12) Patent Application Publication
(10) Pub. No.: US 2005/0004859 A1
(43) Pub. Date: Jan. 6, 2005

(54) Method and apparatus for lottery trade management, and program and recording medium thereof

(75) Inventors: Yuzi Kanazawa, Kawasaki (JP); Hidetoshi Matsuoka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/912,187

(22) Filed: Aug. 6, 2004

Related U.S. Application Data
(63) Continuation of application No. PCT/JP02/01026, filed on Feb. 7, 2002.

(51) Int. Cl. G06F 17/60

(52) U.S. Cl. 705/37; 705/1

(57) ABSTRACT

A lottery trade management method manages a trade of a lottery with a plurality of terminals connected by a network and among the plurality of terminals. That is, the lottery trade management method performs a first trade for the lottery with respect to the plurality of terminals, creates owner information for the lottery on a basis of the first trade, determines a distribution of the lottery on a basis of a result of the first trade, performs a second trade for the lottery among the plurality of terminals after the first trade, and changes the owner information on a basis of a result of the second trade.

### CROSS REFERENCE

This application is a continuation application of a PCT application No. PCT/JP02/01026, filed on Feb. 7, 2002.

### BACKGROUND OF THE INVENTION

1. Field of the Invention

This invention relates to a method and apparatus for a lottery trade management, and a program and recording medium thereof, and more particularly to a method and apparatus for a lottery trade management, and a program and recording medium thereof which make it possible to trade a lottery according to a state of an objective event after a purchase period for the lottery is closed until the event ends.

2. Description of the Related Art

There are various kinds of lotteries. And, there are such lotteries that events such as games of sports and various races are objects of the lotteries, and that a purchaser of the lotteries predicts results of the games and the races and votes for the results. As lotteries of this form, for example, there are a “soccer lottery” and a “horse race”. A participant in a lottery of this form predicts a result of a game, an order of arrival, a point lead, or the like for one or a plurality of events (games or races) and purchases a vote tickets (lottery) according to the prediction before the even is started. When the prediction is right, after a result of the event is decided, the purchaser of the lottery receives a distribution of some profit in accordance with a rate of a distribution (rate of the lottery) which is decided according to a result of voting. When the prediction is not right, usually, there is no distribution.

In the lottery of this type, purchase of vote tickets is closed by a sponsor immediately before an event to be an object of the lottery is started (a game or a race is started). A result of voting is fixed by this closing at the point when the event is started. Consequently, once the event is started, the voting (i.e., prediction) cannot be performs again according to a change in a state of the game or the race.

In addition, a rate of a distribution, which is decided according to a result of voting, is information indicating how people think of a result before the event is started. However, it is after the game or the race is started when an incident directly affecting victory or defeat or the like occurs, and a state changes every moment. For example, a team has scored first, a game is one-sided, a player has got injured, or an unpredictable accident has occurred. In such a change of the state, the rate of a distribution cannot become such information that indicates how people predict a result of the game or the race as a result of the change.

### SUMMARY OF THE INVENTION

It is an object of the present invention to provide a lottery trade management method which makes it possible to trade a lottery even after a purchase period for the lottery is closed and obtain information on the trade.

It is another object of the present invention to provide a lottery trade management apparatus which makes it possible to trade a lottery even after a purchase period for the lottery is closed and obtain information on the trade.

It is still another object of the present invention to provide a lottery trade management program which makes it possible to trade a lottery even after a purchase period for the lottery is closed and obtain information on the trade.

It is further object of the present invention to provide a storage medium for lottery trade management program which makes it possible to trade a lottery even after a purchase period for the lottery is closed and obtain information on the trade.

A lottery trade management method of the present invention manages a trade of a lottery to and among a plurality of terminals connected by a network. The method comprises performing a first trade for the lottery to the plurality of terminals, creating owner information for the lottery on a basis of the first trade, determining a distribution for the lottery on a basis of a result of the first trade, performing a second trade for the lottery among the plurality of terminals after the first trade, and changing the owner information on a basis of a result of the second trade.

Preferably, according to the lottery trade management method of the present invention, a trade index in the second trade is determined on a basis of the distribution, and the second trade is performed using the trade index.

A lottery trade management apparatus of the present invention manages a trade of a lottery to and among a plurality of terminals connected by a network. The apparatus comprises a sales apparatus which performs a first trade for the lottery to the plurality of terminals, creates owner information of the lottery on a basis of a result of the first trade, and determines distribution for the lottery, and a market apparatus which performs a second trade for the lottery among the plurality of terminals after the first trade, and changes the owner information on a basis of a result of the second trade.

According to the lottery trade management method and the lottery trade management apparatus of the present invention, even after the first trade for the lottery is closed following start of an event to be an object of the lottery, the second trade can be performed according to a change in a state of the event with a fixed result of voting (rate of a distribution) as a premise. In addition, separately from a rate of a distribution corresponding to a prediction, information indicating how people predict a result according to the change in a state of the event can be obtained.

A lottery trade management program of the present invention realizes a lottery trade management apparatus which manages a trade of a lottery to and among a plurality of terminals connected by a network. The program comprises causing a computer which is served as the lottery trade management apparatus to execute performing a first trade for the lottery to the plurality of terminals, creating owner information for the lottery on a basis of the first trade, determining a distribution for the lottery on a basis of a result of the first trade, performing a second trade for the lottery among the plurality of terminals after the first trade, and changing the owner information on a basis of a result of the second trade.

According to the lottery trade management program of the present invention, the lottery trade management method and the lottery trade management apparatus described above can be realized. Therefore, as described above, even after the first trade of the lottery is closed following start of an event, the second trade can be performed according to a change in a state of the event with a fixed rate of a distribution as a premise. In addition, information indicating how people predict a result according to the change in a state of the event can be obtained.

The recording medium for the lottery trade management program is a computer readable program recording medium having recorded therein the lottery trade management program described above.

According to the recording medium for the lottery trade management program of the present invention, a program for realizing the lottery trade management method and the lottery trade management apparatus described above can be stored in a recording medium such as a CD-ROM, a CDR/W, or a floppy disk and provided. Thus, the lottery trade management method and the lottery trade management apparatus can be realized easily.

### BRIEF DESCRIPTION OF THE DRAWINGS

FIGS. 1A and 1B are diagrams showing a structure of a lottery trade management system.

FIG. 2 is a diagram showing a structure of a lottery trade management apparatus.

FIG. 3 is an explanatory diagram of a lottery trade, especially FIG. 3A shows an example of a registration request, FIG. 3B shows an example of a purchase request, FIG. 3C shows an example of a trade order request, FIG. 3D shows an example of a primary trade information reference request, and FIG. 3E shows an example of a closing processing request.

FIG. 4 is an explanatory diagram of a lottery trade, especially FIG. 4A shows an example of a registration list, FIG. 4B shows an example of an owner list, FIG. 4C shows an example of a trade order list, and FIG. 4D shows an example of a trade information list.

FIG. 5 is a flowchart showing participant registration processing which is executed by a registration subsystem.

FIG. 6 is a flowchart showing lottery sales processing which is executed by a sales processing unit of a sales subsystem.

FIG. 7 is a flowchart of a sales processing, especially FIG. 7A is a flowchart showing information provision processing which is executed by an information provision processing unit of the sales subsystem, and FIG. 7B is a flowchart showing closing processing which is executed by a closing processing unit of the sales subsystem.

FIG. 8 is a flowchart showing trade processing which is executed by a trade processing unit of a market subsystem.

FIG. 9 is a flowchart of trade processing, FIG. 9A is a flowchart showing information provision processing which is executed by an information provision processing unit of the market subsystem, and FIG. 9B is a flowchart showing decision processing which is executed by a decision processing unit of the market subsystem.

FIG. 10 is a diagram showing an example of a trade for a lottery according to the present invention, especially FIG. 10A shows an example of voting for a lottery in a primary trade, and FIG. 10B shows an example of voting for a lottery in a secondary trade.

FIG. 11 is a diagram showing a specific structure of a lottery trade management system.

### DETAILED DESCRIPTION OF THE PREFERRED EMBODIMENTS

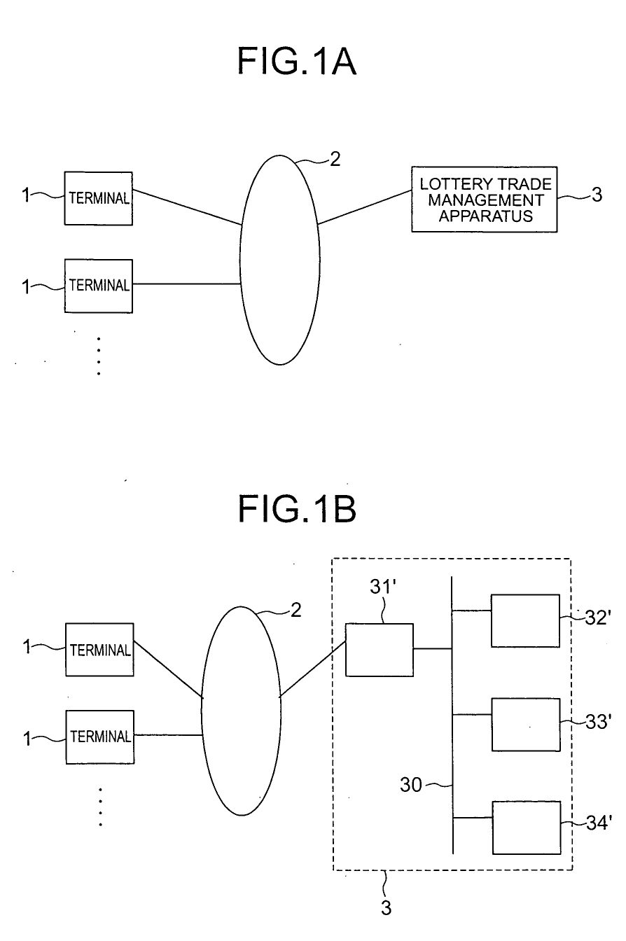

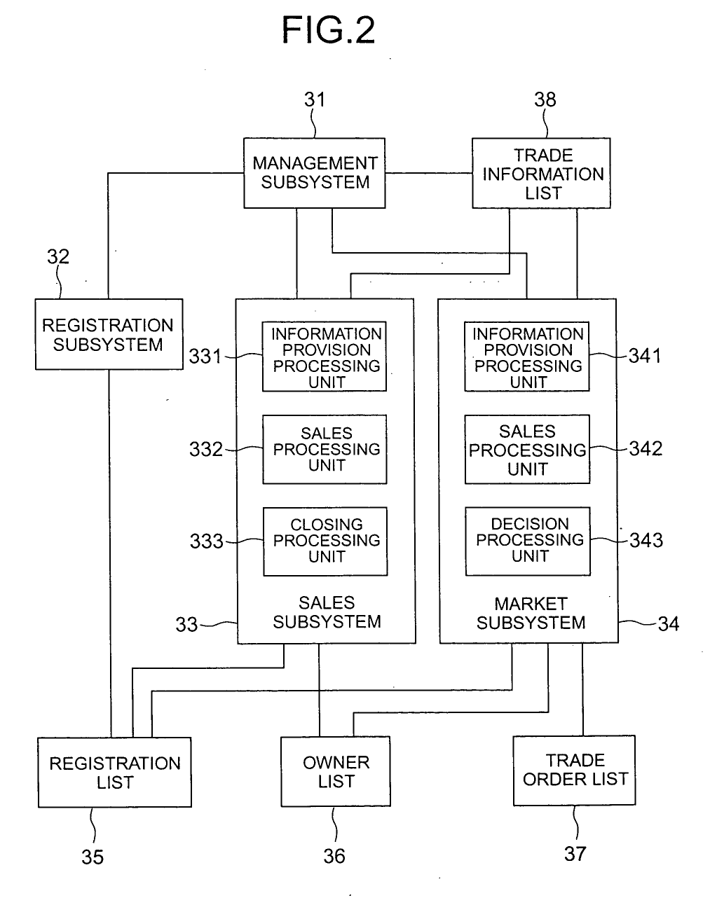

FIGS. 1A and 1B are diagrams showing a lottery trade management system and show a structure of a lottery trade management system which executes a lottery trade management method of the present invention. FIG. 2 is a diagram showing of a lottery trade management apparatus and shows a structure of a lottery trade management apparatus which executes the lottery trade management method of the present invention.

As shown in FIG. 1A, the lottery trade management system has a lottery trade management apparatus 3 which manages a trade of a lottery among a plurality of terminals 1, the plurality of terminals 1 which are used by participants in the lottery, and a network such as the Internet 2 which connects between lottery trade management apparatus 3 and plurality of terminals 1. The lottery trade management apparatus 3 comprises a computer which has an internet connection function and is provided by a lottery trade manager, a provider (an internet service provider or an application service provider), or the like. The terminals 1 are computers which has an Internet connection function and is used by the participants in the lottery. The computer of the terminal 1 comprises a personal computer, a personal digital assistant, a cellular phone provided with an Internet connection function, or the like.

As shown in FIG. 2, the lottery trade management apparatus 3 includes a management subsystem 31, a registration subsystem 32, a sales subsystem 33, and a market subsystem 34 and is provided with a registration list 35, an owner list 36, a trade order list 37, and a trade information list 38. As shown in FIG. 1B, the management subsystem 31, the registration subsystem 32, the sales subsystem 33, and the market subsystem 34 may be provided separated apparatuses 31′, 32′, 33′, and 34′, each of which comprise independent computers. In this case, these apparatuses 31′, 32′, 33′, and 34′ are connected to each other by a network such as a LAN (Local Area Network) 30 and share the registration list 35, the owner list 36, the trade order list 37, and the trade information list 38.

In this embodiment, the lottery trade management system is provided on the Internet 2. That is, in this embodiment, both an ordinary trade of a lottery (hereinafter referred to as primary trade) and a trade of a lottery on a market, which is created by the lottery trade management system, after closing of the primary trade (hereinafter referred to as a secondary trade) are performed on the Internet 2. A rate of the lottery is decided in accordance with a result of the primary trade at a point when the primary trade is closed, and then an event, which is an object of the lottery, is started. According to a state of progress of the event, the secondary trade is performed based upon the decided ratio of the lottery. It is a registered person (the terminal 1 used by the registered person) or a participant who participates in the lottery trade management system, that is, participate in a trade of the lottery. However, anybody can make a registration. Since there are many participants who place an order looking at states of transactions in the primary trade and the secondary trade, the participant is allowed to refer to information on the states of the transactions in the primary trade and the secondary trade.

Thus, the terminal 1 issues a registration request 11, a purchase request 12, a trade order request 13, a primary trade information reference request 14, a secondary trade information reference request 15 to the lottery trade management apparatus 3 through the Internet 2 according to input of an instruction by the participant. On the other hand, a system administrating person of the lottery trade management apparatus 3 issues (or inputs) a closing processing request 16 and a decision processing request 17. The closing processing request 16 is issued at a point when a lottery purchase (primary trade) period ends. In other words, the closing processing request 16 is issued immediately before start of an event. The decision processing request 17 is issued at a point when a secondary trade period ends. In other words, the decision processing request 17 is issued at a point when the event to be an object of prediction ends and a result of the event is decided.

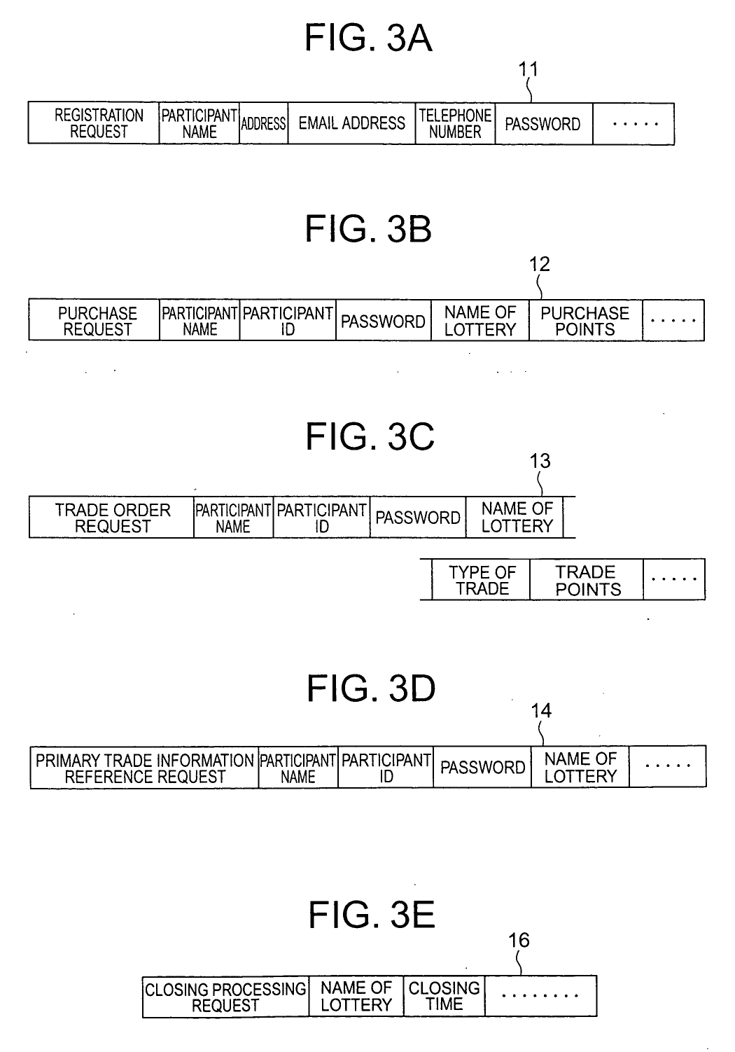

The registration request 11 is issued in a case that the terminal 1 (or participant) makes a registration for participating in the lottery trade management system. Anybody (who owns the terminal 1) can issue the registration request 11 any time. FIG. 3A shows an example of the registration request 11. The registration request 11 includes a participant name, an address, an e-mail address, a telephone number, and a password. The e-mail address is used for various kinds of notification to the participant by an e-mail. The password is designated by the participant at the registration. The password is used for authentication of the participant together with a participant ID (described later) which is notified from the lottery trade management system.

The purchase request 12 is issued in a case that the terminal 1 purchases the lottery in the primary trade. The purchase request 12 can be issued by the participant, and can be issued until the primary trade is closed (the closing processing request 16 is issued) after reception of the primary trade is started. The purchase request 12 includes a prediction of a result of an event (victory or defeat, a point lead, etc.) by the participant and points to be bet on the prediction. FIG. 3B shows an example of the purchase request 12. The purchase request 12 includes a participant name, a participant ID, a password, a name of a lottery (or an ID of the lottery), and purchase points. The name of a lottery specifies the lottery and is unique in the lottery trade management system. The points substitute for money in the lottery trade management system and are used for purchase (or voting) of the lottery. The purchase points are equivalent to a purchase amount. When admitted legally, money may be bet instead of the points.

The trade order request 13 is issued in a case that the terminal 1 trades the lottery in the secondary trade. The trade order request 13 can be issued by the participant, and can be issued until the secondary trade is closed (the decision processing request 17 is issued) after the primary trade is closed. Any participant can issue a buy order, but only a participant, who has participated in the primary trade for the event (or bought the lottery before closing), can issue a sell order. The trade order request 13 includes a lottery which the participant wishes to sell or exchange, and a desired amount (bid price). FIG. 3C shows an example of the trade order request 13. The trade order request 13 includes a participant name, a participant ID, a password, a name of a lottery, a type of a trade, and trade points. A type of a trade indicates distinction as to whether the lottery is to be sold or bought.

The primary trade information reference request 14 is issued in a case that the terminal 1 refers to information on a trade state of the lottery in the primary trade. The secondary trade information reference request 15 is issued in a case that the terminal 1 refers to information on a trade state of the lottery in the secondary trade. Any participant can issue these reference requests. These reference requests include designation of information to be referred to. FIG. 3D shows an example of the primary trade information reference request 14. The primary trade information reference request 14 includes a participant name, a participant ID, a password, and a name of a lottery (which the participant desires to refer to its primary trade information). The secondary trade information reference request 15 is not illustrated because it has substantially the same structure.

FIG. 3E shows an example of the closing processing request 16. The closing processing request 16 includes a name of a lottery and a closing time. The closing time indicates a time when the primary trade was closed (or time when the request was issued) and is a time immediately before start of an event. The decision processing request 17 is not illustrated because it has substantially the same structure.

The management subsystem (or management apparatus) 31 manages input to and output from the lottery trade management system. In other words, the management subsystem 31 sends input by the terminal 1 and the system administrating person to the registration subsystem 32, the sales subsystem 33, and the market subsystem 34 (hereinafter referred to as the registration subsystem 32 and the like), and returns a response such as a result of processing from the registration subsystem 32 and the like to the terminal 1 or the system administrating person.

The management subsystem 31 sends the registration request 11 to the registration subsystem 32 and causes the registration subsystem 32 to process the registration request 11. In addition, the management subsystem 31 sends the purchase request 12 to a sales processing unit 332 of the sales subsystem 33, sends the primary trade information reference request 14 to an information provision processing unit 331 of the sales subsystem 33, and sends the closing processing request 16 to a closing processing unit 333 of the sales subsystem 33, and causes the processing units to process the requests, respectively. Further, the management subsystem 31 sends the trade order request 13 to a trade processing unit 342 of the market subsystem 34, sends the secondary trade information reference request 15 to an information provision processing unit 341 of the market subsystem 34, and sends the decision processing request 17 to a decision processing unit 343 of the market subsystem 34, and causes the processing units to process the requests, respectively.

Prior to the processing of the various requests 12 and the like (the requests 12 to 15 excluding the registration request 11) from the terminal 1, the management subsystem 31 performs well-known authentication processing. The management subsystem 31 refers to the registration list 35 (described later) using the participant ID and the password included in the various requests 12 and the like, and specifies the terminal 1 (participant) which has sent the various requests 12 and the like. When the participant ID and the password are registered in the registration list 35, the management subsystem 31 can specify the terminal 1. In a case that the authentication is successful, the management subsystem 31 sends the various requests 12 and the like to the corresponding processing units above described.

In a case that the requests 12 and the like from the terminal 1 are received anew and processing for other requests of the identical types have already been executed, the management subsystem 31 registers the request received anew in (a tail end of a queue of the request. When the request currently being executed ends, each of the corresponding processing units investigates a corresponding queue. And, when a request which should be executed is joined, each of the corresponding processing units extracts the request from the top and processes the request.

The registration subsystem (or registration apparatus) 32 manages a participant in the lottery trade management system. In other words, upon receiving the registration request 11, the registration subsystem 32 registers (adds) the participant on a basis of the request 11 to the registration list 35. The participant is the person (or terminal 1) registered in the registration list 35. The participant can send an order for a trade of a lottery to the lottery trade management apparatus 3 from the terminal 1 (computer) owned by the participant through the Internet 2.

At the time of registration, the registration subsystem 32 gives a participant ID to the participant and notifies the participant of this participant ID by an e-mail to the e-mail address described in the registration request 11. The participant ID is unique in the lottery trade management system.

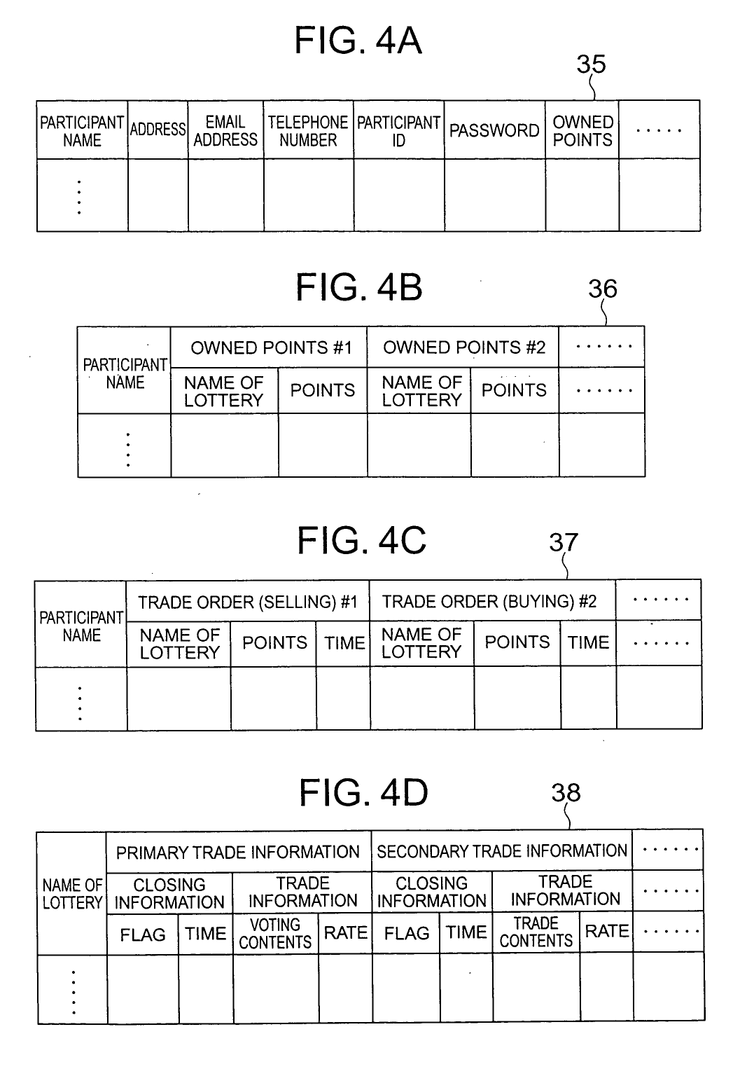

FIG. 4A shows an example of the registration list 35. The registration list 35 records each participants in the lottery trade management system. In other words, the registration list 35 records a participant name, an address, an e-mail address, a telephone number, a participant ID, a password, and owned points for each of the participants. The owned points indicate points which the participant has at that point (points on hand). When the lottery is won (predicts a right result), the participant can obtain new points corresponding to a rate of the lottery. In addition, for example, the participant can acquire goods prepared by a sponsor for the points on hand.

In this embodiment, the participant is not required to pay a fee for participation in the lottery trade management system and a fee for purchasing a lottery. Points for buying a lottery first are given to the participant free of charge. In other words, at a time when the participant is registered in the registration list 35 for the first time, an initial value of owned points of the participant is set to a predetermined value, whereby the predetermined points (e.g., 1000 points) are given to the participant. Moreover, new points may be given to a participant, who continues a contract, free of charge for each predetermined period. For example, a bonus of 1000 points is given for each month. In addition, predetermined points may be given free of charge at a time when a participant traded a lottery of a certain event in a primary trade. Further, when owned points of a participant becomes “0”, predetermined points may be given by the system administrating person of the lottery trade management system free of charge, or the participant may pay a certain amount of money to purchase points.

The sales subsystem (or sales apparatus) 33 manages an ordinary trade or a trade of a lottery in the primary trade in the lottery trade management system. For this purpose, the sales subsystem 33 includes the information provision processing unit 331, the sales processing unit 332, and the closing processing unit 333.

Upon receiving the purchase request 12, the sales processing unit 332 refers to the registration list 35 on a basis of the request12, and causes the terminal 1 to purchase a lottery designated in the purchase request 12 in a range of owned points of the terminal 1. In other words, after confirming whether the participant actually owns the points, the sales processing unit 332 registers the terminal 1, which has become an owner of the lottery, in the owner list 36 and manages who owns how many units (one unit is a minimum unit of a trade) of the lottery. Consequently, when a participant who bought a lottery in the primary trade sells the lottery in the secondary trade, it can be confirmed whether the participant actually owns the lottery.

FIG. 4B shows an example of the owner list 36. The owner list 36 records each participants who own a lottery. In other words, the owner list 36 records a participant name and one or a plurality of ownership information for each of the participants who own the lottery. Single ownership information comprises a name of a lottery (or an ID of a lottery) and owned points for the lottery.

In addition, the sales processing unit 332 successively registers a result of sales (primary trade) of a lottery based upon the purchase request 12 (primary trade information) in the trade information list 38. In other words, the sales processing unit 332 registers a name of the lottery (or an ID of the lottery) in the trade information list 38 when sales of a lottery is determined, creates primary trade information by finding a rate in the primary trade for each content of voting during the primary trade, and registers the primary trade information in the trade information list 38 and successively updates the same. A participant can accurately know the primary trade information during the primary trade by referring to the trade information list 38, and can judge whether or not the primary trade is to be carried out on a basis of the primary trade information.

FIG. 4D shows an example of the trade information list 38. The trade information list 38 records and comprises a result of sales of a lottery based upon the purchase request 12 (primary trade information) and a result of sales of a lottery based upon the trade order request 13 (a secondary trade information). In other words, the trade information list 38 records primary trade information, closing information on primary trade, a secondary trade information, and closing information on a secondary trade for each lottery (or name of a lottery). The primary trade information comprises a rate in the primary trade for each content of voting and is successively changed until closing thereof. The primary trade information after closing the primary trade indicates a decided rate. The closing information on the primary trade comprises a flag indicating whether or not the primary trade has been closed and a time of the closing. At first, the flag is set to “0” indicating that the primary trade has not been closed. The secondary trade information comprises contents and an amount of a trade of a lottery in the secondary trade for each content of voting, is successively added until decision thereof, and indicates a state of transaction in the secondary trade. The decision information on the secondary trade comprises a flag indicating whether or not the secondary trade has been decided and a time of the decision. At first, the flag is set to “0” indicating that the secondary trade has not been decided.

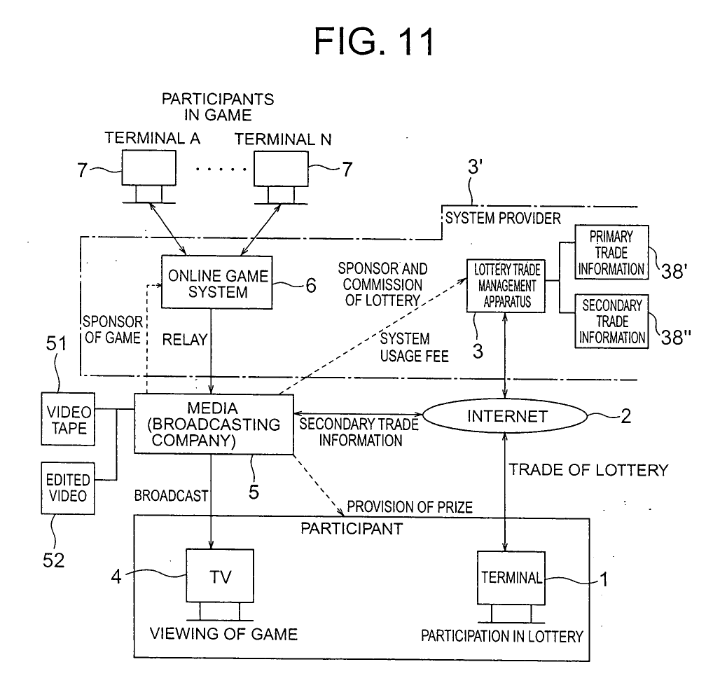

In addition, as described later with reference to FIG. 11, the secondary trade information itself is outputted from the lottery management apparatus 3 (as print or electronic data) and sold to others (e.g., media such as a broadcasting company). Therefore, a recording part of the secondary trade information in the trade information list 38 of FIG. 4D and/or the trade order list 37 of FIG. 4C is actually divided into an update region and an accumulation region (not shown). The update region is successively updated according to a process of the secondary trade during the secondary trade. This update region is used for reference of the secondary trade information. The accumulation region records results of all secondary trades as a history. This accumulation region is used for a trade of the secondary trade information.

Upon receiving the closing processing request 16, the closing processing unit 333 closes a primary trade of a lottery designated in the request 16 on a basis of the request 16, and registers a flag “1”, which indicates a time of the closing and that the primary trade has been closed, in the trade information list 38. A rate of the lottery at the time when a prediction is right for the event is not decided until the primary trade is closed. At a time when the primary trade is closed, a rate is decided according to a result of the primary trade (purchase of a vote ticket) by participant. After the rate is decided, it becomes possible to place a trade order with the market subsystem 34.

Upon receiving the primary trade information reference request 14, the information provision processing unit 331 allows the terminal 1, which issued the primary trade information reference request 14, to refer to the primary trade information (information on a state of the primary trade) on a basis of the request 14. In other words, the information provision processing unit 331 extracts the primary trade information on a lottery designated in the request 14 from the trade information list 38 and sends the primary trade information to the terminal 1 during the primary trade.

The market subsystem (or market apparatus) 34 manages a trade of a lottery in a market created by the lottery trade management system after closing the primary trade in the lottery trade management system, that is, the secondary trade. For this purpose, the market subsystem 34 comprises the information provision processing unit 341, the trade processing unit 342, and the decision processing unit 343.

Upon receiving the trade order request 13, the trade processing unit 342 refers to the owner list 36 or the trade order list 37 on a basis of the request 13, and registers a result of a trade of a lottery in the market created by the lottery trade management system (secondary trade) in the owner list 36 or the trade order list 37. By referring to the owner list 36, when a participant has sold a lottery in the secondary trade, the trade processing unit 342 can confirm whether the participant actually owns the lottery. More specifically, in a case that a transaction of the secondary trade is concluded, the trade processing unit 342 changes the owner list 36 according to a result of the secondary trade. In other words, the trade processing unit 342 deletes ownership information of the lottery from ownership information on a participant who sold the lottery, and adds ownership information of the lottery in ownership information on a participant who bought the lottery. In a case that a transaction of the secondary trade is not concluded, the trade processing unit 342 records the transaction in the trade order list 37. Therefore, the trade order list 37 is a list of trade orders for which a trade in the secondary trade is desired but a transaction has not been concluded yet.

FIG. 4C shows an example of the trade order list 37. The trade order list 37 records each of participants who have placed pending trade orders. In other words, the trade order list 37 records a participant name and one or a plurality of pending trade information for each of the participants who have placed the pending trade orders. The pending trade information comprises a name of a lottery, trade points for the lottery, and a time when the trade order was placed.

Namely, although a unit of trade in the secondary trade may be a point in this way, actually a trade index in the secondary trade is used as described later with reference to FIG. 11. The trade index is a value which is found by dividing a distribution of a lottery, which is determined in the primary trade, by points to be allocated to one unit in a second trade (e.g., 100 points per one unit). Therefore, the number of points serving as the trade index is different from (smaller than) the points per one unit in a first trade.

In addition, the trade processing unit 342 successively registers a result of sales (secondary trade) of a lottery based upon the trade order request 13 (secondary trade information) in the trade information list 38. In other words, the trade processing unit 342 creates secondary trade information by finding the number of trades in the secondary trade for each content of voting in the secondary trade during the secondary trade, registers the secondary trade information in the trade information list 38, and successively updates the secondary trade information. A participant can accurately know the secondary trade information during the secondary trade by referring to the trade information list 38, and can judge whether or not the secondary trade is to be carried out on a basis of the secondary trade information.

Upon receiving the decision processing request 17, the decision processing unit 343 registers a time of the decision and a flag “1”, which indicates that a secondary trade has been decided, in the trade information list 38 on a basis of the request 17, closes and decides a secondary trade of a lottery designated in the request 17, and registers the flag “1” which indicates that the secondary trade has been decided. Owners of a lottery for the event are not decided until the secondary trade is closed. At a time when the secondary trade is closed, owners are decided according to a result of the secondary trade (trade of vote tickets for the second time) by participants. After the decision of the owners, points are distributed to final owners of the lottery according to a rate of the lottery.

Upon receiving the secondary trade information reference request 15, the information provision processing unit 341 allows the terminal 1, which issued the secondary trade information reference request 15, to refer to secondary trade information (or information on a state of a secondary trade) on a basis of the request 15. In other words, the information provision processing unit 341 extracts the secondary trade information from the trade information list 38 for a lottery designated in the request 15, and sends the secondary trade information to the terminal 1.

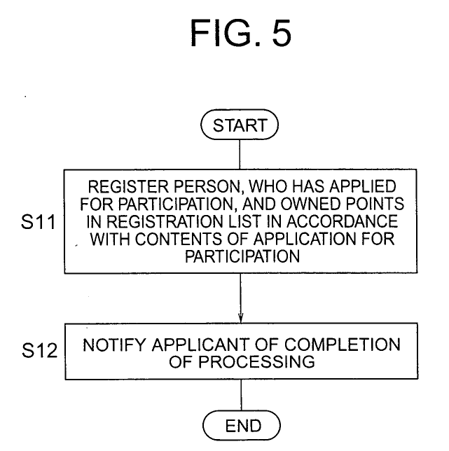

FIG. 5 is a flowchart showing processing for registering a participant which is executed by the registration subsystem 32. Upon receiving the registration request 11, the registration subsystem 32 registers a person, who has applied for participation, and owned points in the registration list 35 according to contents of the application for participation(registration request 11) (step S11), and notifies the participant of completion of the registration processing (step S12). As described above, for example, a predetermined value is given free of charge as the owned points. A participant ID given to the participant is notified to the participant in the notification of the completion of the registration processing. By this registration, the person who applies the participation can trade a lottery as the participant.

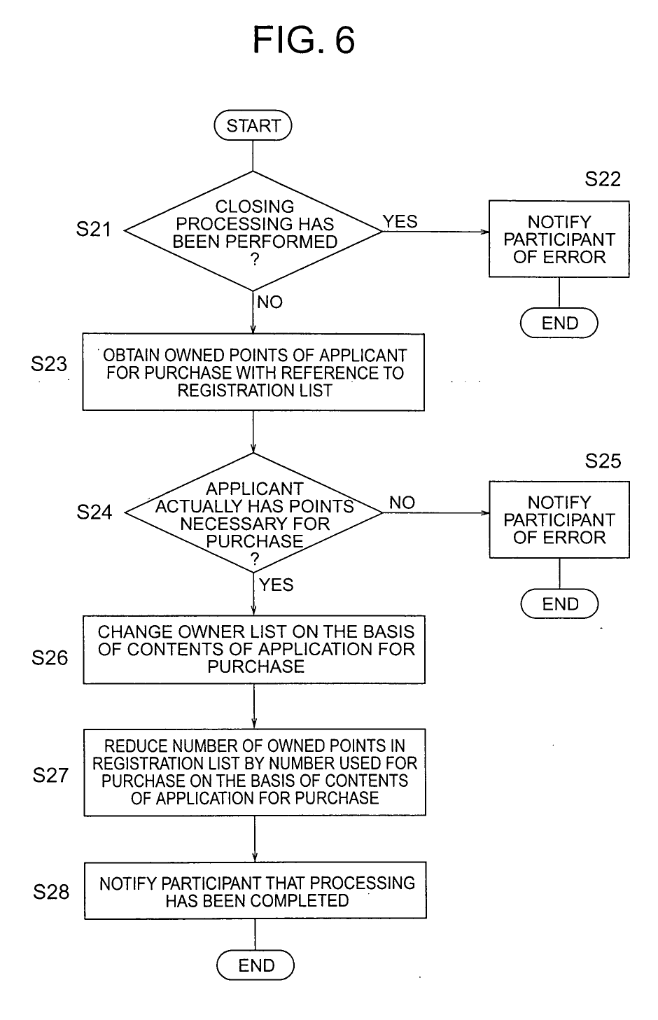

FIG. 6 is a flowchart showing lottery sales processing which is executed by the sales processing unit 332 of the sales subsystem 33.

Upon receiving the purchase request 12, the sales processing unit 332 investigates whether or not closing processing has been performed for the designated lottery by referring to a value of a flag of closing information on a primary of the trade information list 38 (step S21). When the closing processing has been performed (or the flag is “1”), the sales processing unit 332 notifies the participant of an error (step S22), and ends the processing.

When the closing processing has not been performed (or the flag is “0”), the sales processing unit 332 acquires owned points of a participant (applicant), who applied for the purchase, by referring to the registration list 35 (step S23), and investigates whether or not the participant actually has points necessary for the purchase (or the acquired points are equal to or more than the points necessary for the purchase) (step S24). When the participant does not have the points necessary for the purchase, the sales processing unit 332 notifies the participant of an error (step S25), and ends the processing.

When the participant has the points necessary for the purchase, the sales processing unit 332 changes the owner list 36 on a basis of contents of the application for purchase (purchase request 12) (step S26). In other words, the sales processing unit 332 adds the participant in the owner list 36 as an owner of the points for the lottery. Thereafter, the sales processing unit 332 reduces the number of owned points of the participant in the registration list 35 by the number of points used for the purchase (step S27), notifies the participant that the purchase processing has ended (step S28), and ends the processing.

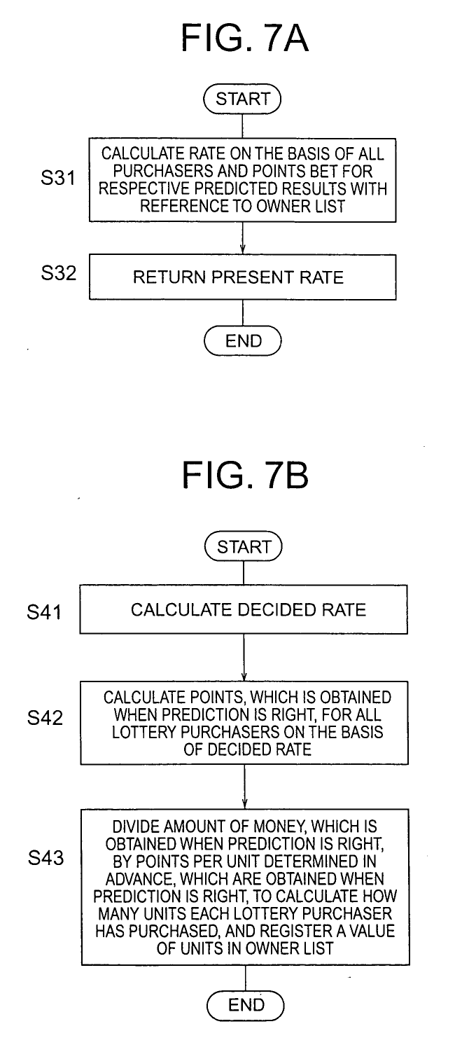

FIG. 7A is a flowchart showing information provision processing which is executed by the information provision processing unit 331 of the sales subsystem 33. Upon receiving the primary sales information reference request 14, the information provision processing unit 331 calculates a rate for the designated lottery on a basis of all purchasers of the lottery (participants) and points bet for each predicted result by referring to the owner list 36 (step S31), and returns a rate at present (at that time) of the lottery to the terminal 1 which sent the request 14 (step S32).

FIG. 7B is a flowchart showing closing processing which is executed by the closing processing unit 333 of the sales subsystem 33. Upon receiving the closing processing request 16, the closing processing unit 333 calculates a decided rate for the designated lottery in the same manner as step S31 (step S41), and calculates points, which is obtained at the time when a prediction is right, for all participants who purchased the lottery on a basis of the decided rate (step S42). Moreover, the closing processing unit 333 divides an amount of money (or points), which is obtained when a prediction is right, by points per one unit determined in advance, which are obtained when a prediction is right, to calculate how many units each of the participants purchased, and registers the calculated value in the owner list 36 (step S43).

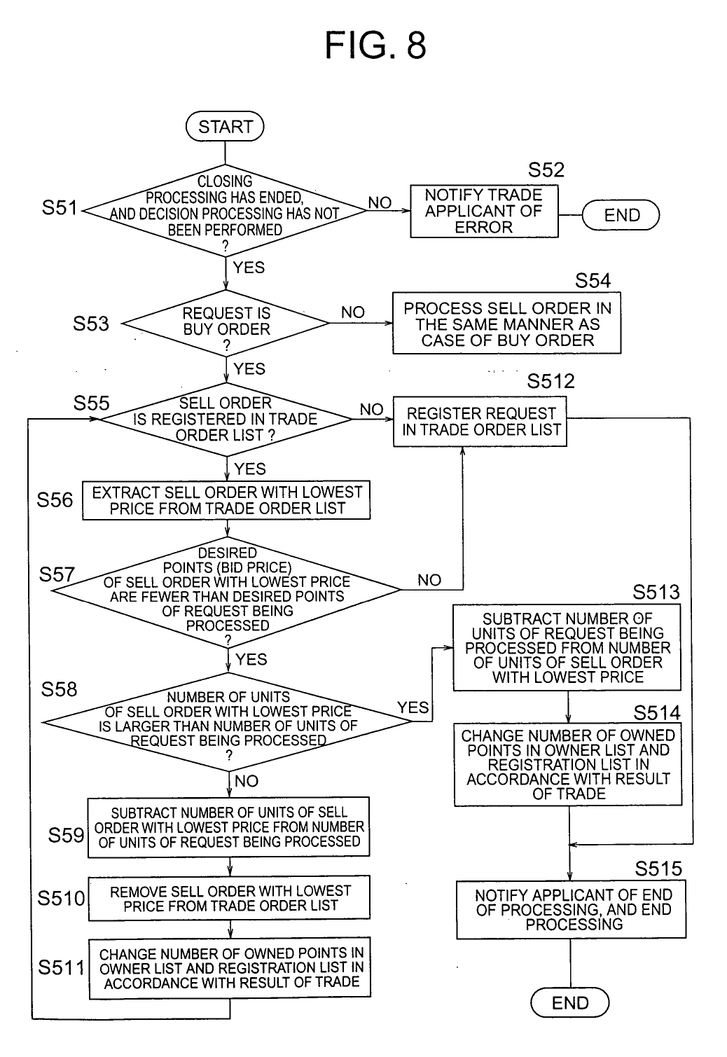

FIG. 8 is a flowchart showing trade processing which is executed by the trade processing unit 342 of the market subsystem 34.

Upon receiving the trade order request 13, the trade processing unit 342 investigates whether or not closing processing has ended and decision processing has not been performed for the designated lottery, by referring to a value of a flag of closing information on a primary trade and a value of a flag of decision information of secondary trade in the trade information list 38 (step S51). When the values of the flags do not satisfy the condition, the trade processing unit 342 notifies a participant, who applied for the trade, of an error (step S52), and ends the processing. When the values of the flags satisfy the condition, the trade processing unit 342 investigates whether or not the trade order request 13 is a buy order (step S53).

When the trade order request 13 is not a buy order (or is a sell order), the trade processing unit 342 processes the sell order in the same manner as processing for a buy order to be described below (step S54). In other words, in step S54, the trade processing unit 342 executes steps S55 to S515 for the sell order in the same manner as the buy order. Therefore, the processing for the sell order will not be described here.

When the trade order request 13 is a buy order (or is not a sell order), the trade processing unit 342 further investigates whether or not a sell order corresponding to the buy order is registered in the trade order list 37 (step S55). When a corresponding sell order is registered, the trade processing unit 342 extracts a sell order with a lowest price from the trade order list 37 (step S56), and investigates whether or not desired points (bid price) in the sell order with the lowest price are lower than desired points of the trade order request 13 (step S57). When the bid price is lower than the desired points of the request 13, the trade processing unit 342 further investigates whether or not the number of units of the sell order with the lowest price is larger than the number of units of the request 13 (step S58).

When the number of units of the sell order with the lowest price is not larger (is smaller) than the number of units of the request 13, the trade processing unit 342 subtracts the number of units of the sell order with the lowest price from the number of units of the request 13 (step S59), and removes the sell order with the lowest price from the trade order list 37 (step S510). And then, according to a result of this trade, the trade processing unit 342 changes owners or the number of owned points in the owner list 36, and also changes the number of owned points in the registration list 35 (step S511). Thereafter, the trade processing unit 342 repeats step S55 and the subsequent steps until no unit of the request 13 (or the sell order) is left (that is, finally, the trade processing unit 342 proceeds from step S58 to step S513).

When it is found in step S58 that the number of units of the sell order with the lowest price is larger than the number of units of the request 13, the trade processing unit 342 subtracts the number of units of the request 13 from the number of units of the sell order with the lowest price (step S513). And then, according to a result of this trade, the trade processing unit 342 changes owners or the number of owned points in the owner list 36, and also changes the number of owned points in the registration list 35 in accordance with a result of this trade (step S514). Thereafter, the trade processing unit 342 notifies a participant, who placed the sell order, of end of the processing, and ends the processing (step S515).

When it is found in step S55 that a sell order corresponding to the buy order is not registered in the trade order list 37, the trade processing unit 342 registers the buy order request 13 in the trade order list 37 (step S512), notifies the participant, who placed the buy order, of end of the processing, and ends the processing (step S515). In addition, when it is found in step S57 that the desired points (bid price) in the sell order with the lowest price are not lower than the desired points of the trade order request 13, the trade processing unit 342 executes steps S512 and S515 in the same manner.

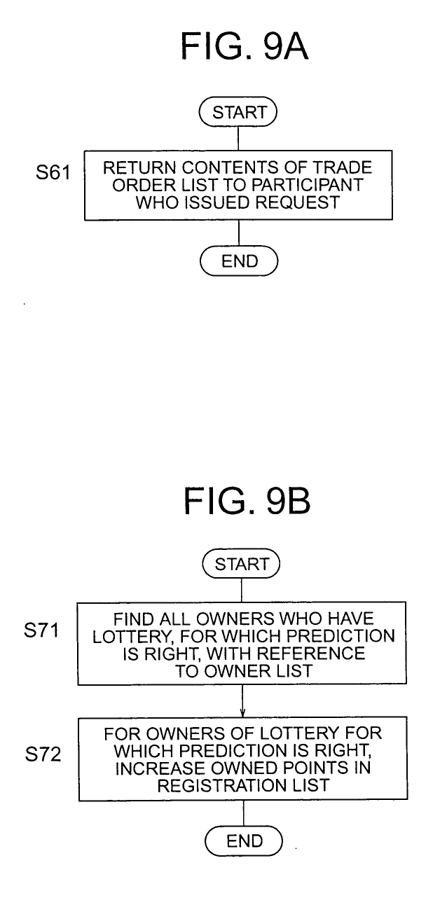

FIG. 9A is a flowchart showing information provision processing which is executed by the information provision processing unit 341 of the market subsystem 34. Upon receiving the secondary trade information reference request 15 the information provision processing unit 341 returns all contents of the trade order list 37 concerning with the designated lottery to the terminal 1 which sent the request 15 (step S61).

FIG. 9B is a flowchart showing decision processing which is executed by the decision processing unit 343 of the market subsystem 34. Upon receiving the decision processing request 17, the decision processing unit 343 extracts all participants, who own a lottery for which a prediction is right, concerning with the designated lottery by referring to the owner list 36 (step S71). And then, concerning with the participants who own the lottery for which the prediction is right, the decision processing unit 343 increases owned points of the participants in the registration list 35 by a value indicating how many units the participants are recorded as purchased in the owner list 36 (step S72).

Next, a trade of a lottery in the lottery trade management system of the present invention will be described in accordance with specific examples.

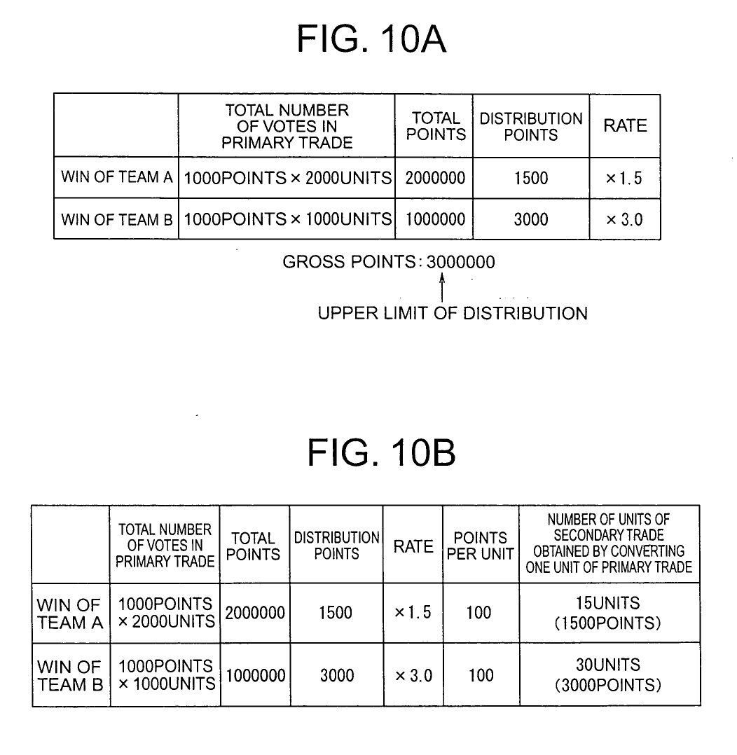

FIG. 10A shows a first example. For example, a team A and a team B play a match in a game of sports. Concerning the game, the lottery trade management apparatus 3 puts an advertisement on the Internet 2 or the like to the effect that a lottery is sold for “1000 points per unit” for the game. A person (or terminal 1) registered in the registration list 35, who has seen this advertisement, buys (polls a vote or bets for) the lottery. The sales subsystem 33 closes a primary trade at a time when the game is started according to the closing processing request 16. It is assumed that, at this time, there are votes of 2000 units for victory of the team A and 1000 units for victory of the team B as shown in FIG. 10A. Namely, according to this data, at this time, more participants think that the team A would win. Neglecting a share of a bookmaker, in this case, a distribution at the time when the team A wins is 1500 points per one unit (1000 points) (1500 points is a value found by dividing a sum of total points (3000000) by the number of sold units (2000)), and a rate of the distribution is 1.5 (1.5 is a value found by dividing the distribution point (1500) by the points at the time of sales (1000)), and a distribution at the time when the team B wins is 3000 points per one unit, and a rate of a distribution is 3. In addition, an amount of a distribution depending upon the primary trade (in this case, 3000000 points) never changes even through a secondary trade. On the other hand, a size of a market of the secondary trade may exceed a size of a market of the primary trade (in this case, 3000000 points).

Thereafter, the game is started, and the market subsystem 34 starts the secondary trade. In a middle of the game, such incident may occur that a main player of the team A has got injured or that the team B has scored first, for example. In this case, it can be judged that possibility of victory of the team A has decreased. Thus, a participant #1 puts a bought lottery on sale in the market subsystem 34 with a risk of some loss. On the other hand, there is a participant #2 who still thinks at this time that the team A would win. When the above participant #2 judges that a price presented by the participant #1, who places the sell order, is low, the participant #2 sends an order for buying the lottery to the market subsystem 34. Consequently, a transaction is concluded between the participants #1 and #2. For the participant #1, when the team A loses, a value of the lottery is reduced to “0”. However, by selling the lottery in the secondary trading, the participant #1 can prevent the value from being reduced to “0”. On the other hand, the participant #2 can additionally buys the lottery or purchases the lottery anew at a price lower than an initial sales price, which the participant #2 thinks advantageous, by buying the lottery in the secondary trade.

Here, points (price) of a trade in the secondary trade are basically formed arbitrarily according to a balance between demand and supply of the trade as in a stock market. Consequently, for example, in the market subsystem 34 (i.e., the secondary trade), the lottery of “1000 points per unit” bet on victory of the team A may be traded for 825 points, and the lottery of “1000 points per unit” bet on victory of the team B may be traded for 1350 points. Namely, according to this data, after the game was started, the number of participants, who think that the team A would lose and the team B would win, has increased. In this way, in the secondary trade, an amount of money (points), for which a lottery of one unit (e.g., 1000 points) is traded, successively fluctuates according to a progress of the game.

FIG. 10B shows a second example. As described above, transaction points (price) of a lottery in the market subsystem 34 (i.e. the secondary trade) fluctuates every moment according to a progress of a game. Therefore, a participant needs to instantly judge whether the transaction points is high or low. However, for that purpose, it is necessary to compare transaction points after considering a final rate which is realized when each team wins, and it is difficult to instantly make the judgment.

Thus, the market subsystem 34 normalizes a distribution at the time when a lottery is bought. That is, the market subsystem 34 determines a trade index indicating “when it is assumed that, when a prediction is right, there is for example a distribution of X points (e.g., X=100) per unit, how many units would be owned”. In other words, a value of points in the sales subsystem 33 and a value of points in the market subsystem 34 are converted into different values according to a result (a distribution, a rate, or the like) of a primary trade in the sales subsystem 33. Alternatively, a distribution per one unit at the time when a prediction is right is determined according to the result of the primary trade, and the number of units purchased in the primary trade is converted into the number of units which are used in the secondary trade on a basis of the determined distribution.

According to the above-described example, a participant, who has actually polled a vote of one unit (bet 1000 points) for victory of the team A in the primary trade, would receive a distribution of 1500 points. Thus, it is assumed that, as shown in FIG. 10B, the participant has virtually polled a vote of 15 units in the secondary trade. That is, the trade index is “15”. A participant, who has actually polled a vote of one unit (bet 1000 points) for victory of the team B, would receive a distribution of 3000 points. Thus, it is assumed that the participant has virtually polled a vote of 30 units in the secondary trade. That is, the trade index is “30”. Consequently, a distribution, which is finally obtained per one virtual unit or the trade index “1”, is the same (in this case, 100 points).

According to the above-described example, a participant #3, who has actually polled a vote of one unit (bet 1000 points) for victory of the team A, becomes an owner of a lottery of 15 units (×100 points=1500 points). It is assumed that this participant #3 has sold the lottery for 55 points per unit in the market subsystem 34. On the other hand, a participant #4, who has actually polled a vote of one unit (bet 1000 points) for victory of the team B, becomes an owner of a lottery of 30 units (×100 points=3000 points). It is assumed that this participant #4 has sold the lottery for 45 points per unit in the market subsystem 34. In this case, at that time, it is apparently seen that the team A has gained more popularity. Namely, since the lottery bet on victory of the team A is 55 points per unit, equation 55=825/(1500/100) is obtained, so that it is equal that a lottery of “1000 points per unit” is traded for 825 points. In addition, since the lottery bet on victory of the team B is 45 points per unit, equation 45=1350/(3000/100) is obtained, so that it is equal that a lottery of “1000 points per unit” is traded for 1350 points. That is, a trade situation is not easily understood using points of a value identical with points in the primary trade such as 825 points and 1350 points, but the trade situation is clarified by using points in the secondary trade which have a value different from points in the primary trade.

FIG. 11 shows an example of a structure of the lottery trade management system of the present invention. Since it is prohibited to bet money in some countries, points are used for voting and trade for a lottery rather than money as described above. However, in the point system, a sponsor of a lottery does not benefit from the lottery itself, and participants do not have much fun.

Thus, as shown in FIG. 11, the lottery trade management system is associated with an on-line game system 6 and/or a media 5. That is, a sponsor of an event (e.g., a game of sports) or a medium 5, which broadcasts the event, sponsors a lottery for the event. The sponsor of the lottery (e.g., a broadcasting company) enters into an agreement with a system provider 3′ (e.g., ISP or ASP), which provides a lottery trade system, and causes the system provider 3′ to execute a trade of the lottery with the lottery trade system. The sponsor of the lottery pays a system usage fee to the system provider 3′. A participant enters into an agreement with the medium 5 for viewing of the event, and enters into an agreement with the system provider 3′ for participation in the trade of the lottery. The participant pays a viewing fee to the medium 5, and pays a system usage fee to the system provider 3′. In addition, the sponsor of the lottery provides a prize to the participant through the system provider 3′. For example, the prize is “a ball with a signature of a player”, “a right to preferentially purchase a ticket for a good seat in a popular game”, or the like.

In addition, even in a gamble admitted by law such as a horse race, according to this system, a participation fee for a participant (i.e., a price of a vote ticket) can be reduced by an amount equivalent to a prize. In this case, the participant pays a price to purchase a vote ticket (or points) and liquidates points obtained by winning a lottery or uses the points to purchase a prize. Therefore, a participation fee for the participant is reduced, and a sponsor can expect an increase of participants.

Consequently, the sponsor of the lottery can expect an increase of participants in the lottery and viewers of a game. That is, since it is possible that the lottery can be traded in more advantageous conditions than in the past, and since there is more fun in an event, participants in the lottery increases. In addition, in order to trade the lottery advantageously, the participants have to know a present situation. Therefore, it is expected that the participants in the lottery view the event surely with a television 4 or the like. Consequently, it is expected to increase a viewing rate and to increase in the number of subscribers in a pay broadcasting (e.g., CS). Moreover, it is expected to increase sponsors for a program.

On the other hand, it is inefficient for the sponsor of the lottery to produce the on-line game system 6, which is an event, by itself and to collect participants in the lottery one by one. Thus, the sponsor of the lottery asks the system provider 3′ to provide software and a system for an on-line game, and participants (or terminals 7) of the on-line game enter into an agreement with the system provider 3′. Namely, although not shown in the figure, the on-line game is a game utilizing the Internet. Consequently, the sponsor of the lottery or the medium 5 is not required to produce the on-line game system 6 by itself. In addition, the participants in the on-line game are not required to enter into a game participation agreement many times for each event, each sponsor, and each medium 5.

Namely, the system provider 3′ can receive production cost for the on-line game from the medium 5. In addition, the system provider 3′ can expect an increase of participants in the on-line game. Moreover, the system provider 3′ can receive a system usage fee from the sponsor, and can also receive commissions from the participants.

On the other hand, a participant in the lottery can buy the lottery without paying a participation fee, can enjoy a game by buying the lottery, and can obtain a chance of getting a prize when the lottery is won. In addition, the participant in the lottery does not pay a bet, and on the other hand, the sponsor is not directly benefited from the game. Therefore, this lottery trade is not a gamble but can be considered the same as “a lot” which is performed generally for sales promotion. Moreover, the participant in the lottery is not required to enter into an agreement with individual event sponsors and media 5 and can enjoy a plurality of events simply by entering into an agreement with the system provider 3′. In addition, since points (a transaction price in the secondary trade) fluctuate depending upon a present situation, for the participant in the lottery, a real-time nature increases, and amusement increases.

In addition to the above, the medium 5 can obtain secondary trade information 38″ from the system provider 3′ by sponsoring the lottery. In other words, the medium 5 can obtain price fluctuation information in the secondary trade. In general, there is a “highlight”, which influences the whereabouts of a match, in an amusement game or an excellent match. Therefore, a transaction price in the secondary trade in the lottery trade system fluctuates significantly before and after the “highlight”. Consequently, it can be communicated to others simply and objectively how amusing an event was by watching a state of the fluctuation in the transaction price. In this way, the secondary trade information 38″ itself has a high value. Thus, the system provider 3′ can sell the secondary trade information 38″ itself to the medium 5 and the like.

The sponsor of the lottery can acquire such secondary trade information 38″. In addition, the sponsor of the lottery may sell the acquired secondary trade information 38″ to the medium 5. For example, the medium 5 edits a record (VTR) 51 of the event held by the medium 5 on a basis of the secondary trade information 38″. For example, the medium 5 can create an edited video 52 or the like in which highlight scenes are collected, without intervention of others' help, by finding time when the fluctuation in the trade price is large (or the price is high) in the secondary trade information 38″, and connecting and editing recorded screens (scenes) at that time. Moreover, the medium 5 can sell this edited video 52 or the like.

As described above, according to the lottery trade management method and apparatus of the present invention, even after a first trade of a lottery is closed following start of an event to be an object of the lottery, a second trade can be performed according to a change in a situation of the event with a result of a fixed vote (a rate of a distribution) as a premise. In addition, separately from a rate of a distribution equivalent to a prediction, information indicating how people predict a result according to a change in a situation of the event can be obtained.

In addition, according to the lottery trade management program of the present invention, the lottery trade management method and apparatus as described above can be realized easily. Therefore, as described above, even after a first trade of a lottery is closed following start of an event, a second trade can be performed according to a change in a situation of the event. In addition, information indicating how people predict a result according to a change in a situation of the event can be obtained.

According to the recording medium for the lottery trade management program of the present invention, a program realizing the lottery trade management method and apparatus as described above can be stored in a recording medium such as a CD-ROM and provided. Thus, the lottery trade management method and apparatus can be easily realized.

1. A lottery trade management method for managing a trade of a lottery to and among a plurality of terminals connected by a network, the method comprising:
performing a first trade for the lottery to the plurality of terminals;
creating owner information for the lottery on a basis of the first trade;
determining a distribution for the lottery on a basis of a result of the first trade;
performing a second trade for the lottery among the plurality of terminals after the first trade; and
changing the owner information on a basis of a result of the second trade.

2. The lottery trade management method according to claim 1, wherein a trade index in the second trade is determined on a basis of the distribution, and
wherein the second trade is performed using the trade index.

3. The lottery trade management method according to claim 1,
wherein the trade index is a value found by dividing the distribution of the lottery by points per one unit in the second trade, and the points are different from points per one unit in the first trade.

4. The lottery trade management method according to claim 1, further comprising:
providing a registration list which registers the plurality of terminals; and
giving points to be used for a trade of the lottery to each of the plurality of terminals free of charge.

5. The lottery trade management method according to claim 1, further comprising:
creating and successively updating information on the first trade during the first trade for the lottery; and
allowing reference to the information on the first trade from the plurality of terminals during the first trade.

6. The lottery trade management method according to claim 1, further comprising:
creating and accumulating information on the second trade during the second trade for the lottery; and
allowing reference to the information on the second trade from the plurality of terminals during the second trade.

7. The lottery trade management method according to claim 1, further comprising:
creating and accumulating information on the second trade during the second trade for the lottery; and
outputting the information on the second trade after the second trade.

8. A lottery trade management apparatus for managing a trade of a lottery to and among a plurality of terminals connected by a network, the apparatus comprising:
a sales apparatus which performs a first trade for the lottery to the plurality of terminals, creates owner information of the lottery on a basis of a result of the first trade, and determines distribution for the lottery; and
a market apparatus which performs a second trade for the lottery among the plurality of terminals after the first trade, and changes the owner information on a basis of a result of the second trade.

9. A lottery trade management program for realizing a lottery trade management apparatus which manages a trade of a lottery to and among a plurality of terminals connected by a network, the program comprising:
causing a computer which is served as the lottery trade management apparatus to execute:
performing a first trade for the lottery to the plurality of terminals;
creating owner information for the lottery on a basis of the first trade;
determining a distribution for the lottery on a basis of a result of the first trade;
performing a second trade for the lottery among the plurality of terminals after the first trade; and
changing the owner information on a basis of a result of the second trade.

10. A computer readable program recording medium recording a lottery trade management program for realizing a lottery trade management apparatus which manages a trade of a lottery to and among a plurality of terminals connected by a network, the program comprising:
causing a computer which is served as the lottery trade management apparatus to execute:
performing a first trade for the lottery to the plurality of terminals;
creating owner information for the lottery on a basis of the first trade;
determining a distribution for the lottery on a basis of a result of the first trade;
performing a second trade for the lottery among the plurality of terminals after the first trade; and
changing the owner information on a basis of a result of the second trade.
